(19) United States
(12) Patent Application Publication
(10) Pub. No.: US 2025/0087708 A1
(43) Pub. Date: Mar. 13, 2025

(54) Catalyst-Coated Membranes, Catalyst Coated Membrane-StyleMembrane Electrode Assemblies and Methods of Fabrication Thereof

(71) Applicant: Advent Technologies Holdings,Inc., Boston, MA (US)

(72) Inventors: Vincente Galvin, Boston, MA (US); Cynthia Olson, Boston, MA (US); Sean Vale, Boston, MA (US); Jake Kracinovich, Boston, MA (US); Ryan Pavlicek, Boston, MA (US); Emory S. De Castro, Boston, MA (US)

(21) Appl. No.: 18/605,103

(22) Filed: Mar. 14, 2024

Related U.S. Application Data
(60) Provisional application No. 63/491,436, filed on Mar. 21, 2023.

(51) Int. Cl. H01M 4/90; H01M 4/88; H01M 8/1004; H01M 8/1018

(52) U.S. Cl. CPC H01M 4/9058; H01M 4/8807; H01M 4/881; H01M 4/8828; H01M 8/1004; H01M 8/1018; H01M 2300/0082

(57) ABSTRACT

The present invention provides a process for making a membrane electrode assembly (MEA) through a catalyst coated membrane (CCM) with phosphoric acid doped polymer electrolyte membrane. The polymer electrolyte membranes are composed of cationic-biphosphate ion pairs, with low acid content. The CCMs can be obtained either by direct coating on a membrane or to a transfer decal in a single step. The decal transfer is completed under mild temperature and pressure holds and show complete transfer of catalyst.

### REFERENCE TO RELATED APPLICATIONS

This application claims the benefit of U.S. Provisional Patent Application Ser. No. 63/491,436, filed Mar. 21, 2023, entitled “Improved Catalyst-Coated Membranes, Catalyst Coated Membrane-Style Membrane Electrode Assemblies and Methods of Fabrication Thereof,” the teachings of which are incorporated herein by reference.

### FIELD OF INVENTION

This invention relates to a process of improving development of membrane electrode assemblies (MEA) for high temperature phosphoric acid fuel cells. The MEAs are prepared by catalyst coated membranes (CCM). The CCMs provide improved catalyst-membrane interface.

### DESCRIPTION OF THE RELATED ART

Fuel cells are devices which convert chemical energy into electrical energy and are vital in mitigating the global climate crisis. The use of hydrogen from renewable energy sources combined with fuel cells provides an avenue for carbon-neutral power generation. Commercialization of fuel cells in several sectors is ongoing, however further technological advancements are necessary to enhance the cost competitiveness of fuel cells.

Two general types of fuel cells are low temperature and high temperature fuel cells, which can exist as either proton or anion exchange systems. Low temperature proton exchange membrane fuel cells typically utilize Chemours Nafion® polymeric materials, originally developed by Dupont, for membranes which require high hydration levels to achieve adequate proton conductivity. Low temperature fuel cells are currently being utilized in fuel cell vehicles and one major reason for this is the high performance with low precious metal catalyst requirements. One of the major factors for the low catalyst loadings is that the membrane electrode assembly (MEA) is commonly fabricated by a catalyst coated membrane (CCM) method. This results in a decrease in the interfacial resistance between the catalyst layer and the membrane. Two of the most common methods to obtain CCMs are decal transfer and direct coating on the surface of the membrane. The decal transfer involves coating of the catalyst on a transfer medium followed by transferring the catalyst layer onto the membrane via a hot-pressing protocol. However, the need for high hydration levels requires complex humidification setups and water management.

High temperature fuel cells solve the issue of humidification and water management as well as increased tolerance of impure hydrogen. To operate at temperatures greater than the boiling temperature of water, phosphoric acid doped membranes, most typically polybenzimidazole (PBI), have been utilized as the polymer electrolyte membrane. The use of phosphoric acid doped PBI, however requires high acid content, approximately 90-95 wt. % to provide sufficient conductivity in anhydrous conditions. The high phosphoric acid content results in surface wetness which leads conventional methods of catalyst coated membranes to be unsuccessful. One approach to circumvent this has been to prepare catalyst coated membranes prior to acid doping, however this procedure results in expansion of the membrane which in turn will cause deformation to the catalyst layer. Moreover, excess liquid would remain in the catalyst layer causing flooding of the catalyst with excess phosphoric acid (J. Power Sources, 288, 2015, 121-127). An alternative approach that has been employed has been preparation of catalyst coated membranes on undoped PBI membranes and acid doping the gas diffusion layer, however the redistribution of acid to the membrane would be minimal and would still result in membrane expansion (J. Power Sources, 266, 2014, 107-113). U.S. Pat. No. 9,490,488B2, teaches the preparation of catalyst coated membrane with an acid doped PBI membrane. However, the transfer occurs after a multistep pressing procedure involving prolonged pressure hold periods and elevated temperatures, which result in excessive loss of phosphoric acid and an unscalable process. Thus, catalyst coated gas diffusion layers remains the most widely used method of preparing membrane electrode assemblies for high temperature fuel cells. U.S. Pat. No. 10,622,657B1 and 2022/0052357A1, describe polymer electrolyte membranes containing quaternary ammonium functional groups that interact with phosphoric acid in a cationic-biphosphate ion pair. These membranes require lower acid doping to achieve comparable proton conductivities to conventional PBI, are operable at a wider temperature range and display improved retention of acid.

### SUMMARY OF THE INVENTION

The present invention overcomes previous limitations of phosphoric acid doped MEA preparation. With the use of cationic-bisphosphate ion pair-based polymer electrolyte membranes, the transfer of catalyst to the membrane can be achieved under mild conditions by either direct coating or decal transfer.

Briefly, the present invention provides a method for preparing membrane electrode assemblies (MEAs) involving the direct transfer of catalyst to a phosphoric acid doped polymer electrolyte membrane. Preferably, the catalyst layer is coated directly onto the membrane or as a decal from a release transfer medium. Preferably, said polymer electrolyte membrane is composed of a polymer with cationic-biphosphate ion pairs groups.

Further aspects of the invention provide methods as described above of preparing catalyst-coated membranes, e.g., for use in MEAs.

Still further aspects of the invention catalyst-covered membranes, of the type described above, and MEAs incorporating such membranes.

Additional aspects, features and benefits of the invention will be evident from the detailed description and figures.

### BRIEF DESCRIPTION OF DRAWINGS

A more complete understanding of the invention may be attained by reference to the drawings, in which:

FIG. 1A is a scanning electron micrograph of decal prepared MEA according to the present invention.

FIG. 1B is a scanning electron micrograph of a decal prepared MEA according to the present invention.

FIG. 2 is an MEA having a catalyst-coated membrane according to the invention.

FIGS. 3A and 3B illustrate methods according to the invention.

### DETAILED DESCRIPTION

The present invention relates to improved methods of preparing catalyst coated membranes and membrane electrode assemblies (MEAs) for high temperature fuel cells.

The method according to the present invention involves the preparation of catalyst coated membranes (CCMs) via direct coating or transfer of catalyst as a decal onto the membrane. Any suitable polymer electrolyte membrane may be employed. Typically, a phosphoric acid doped polymer electrolyte membrane with quaternary ammonium groups is used. A preferred practice for the coating of the membrane is to maintain a phosphoric acid content in the range of 0.5-20 mg/cm2. The direct membrane coating may be prepared by coating or depositing the catalyst ink by machine or manual methods. The catalyst decal may be prepared by coating or depositing the catalyst ink on a release medium by either machine or manual methods. Machine and manual methods involve but are not limited to hand brush painting, spray coating, rod coating, fluid bearing die coating, slot-fed, and knife coating. Coatings may be completed in one pass or multiple passes.

Any suitable catalyst ink may be used. The catalyst ink may be composed of one or more polymeric material which act as a binder and/or proton conductor. The polymeric binder materials are preferably polymer electrolyte materials, with either neutral or charged functional groups. Preferably, a sulfonic acid, quaternary amine cation, or phosphonate functional group. The polymeric materials may be used as a dispersion or as solid. Typically, a dispersion of the polymeric materials is utilized. The dispersion of the polymer materials may be prepared in a suitable solvent which may be aqueous, organic or a mixture of aqueous and organic solvents. The catalyst ink contains a dispersion of catalyst particles and polymeric binder. The catalyst particles may be any suitable catalyst. Typically, the catalyst particles are carbon supported particles. The carbon supported particles are typically composed of 40-90% carbon and 10-60% catalyst by weight. The catalyst may be any platinum alloy of a transition metal or any mixture of two or more transition metals, or simply platinum on carbon black. The catalyst ink contains 5-15% solids, where solids are polymeric binder and catalyst particles. In addition, the ink may contain 0-10% additives to improve properties of the ink, catalyst coating and/or catalyst layer. Properties including but not limited to particle size, dispersion, porosity, hydrophobicity, surface tension and stability. Preferred ink properties for obtaining adequate coating onto the membrane and/or transfer medium includes but is not limited to viscosity from 30-10000 cP, solid particle size from 0.01-5 μm and surface tension from 15-80 mN/m. Final CCMs, regardless of being constructed via direct applications or transfer medium can range of platinum or platinum alloy loading from 0.01 mg/cm² to 5 mg/cm². One preferred quality for the CCM is having strong adhesion between the catalyst-electrode layer and the membrane, and if using a decal method, low adhesion to the decal transfer medium. Adhesion of the catalyst-electrode layer typically needs at least 100 J/m² and up to 1,000 J/m² to achieve good contact and low interfacial resistance for the CCM unit. Alternatively, the peel force can be cited as well, and here a minimum of 100 N/m up to 1,000 N/m results in good CCMs where a N/m is the force needed to peel a one-meter-wide strip of material from its adhesion to the substrate.

For the decal transfer any suitable transfer medium may be used as a release medium, including but not limited to polytetrafluorethylene (PTFE), polyimides, fluorinated ethylene propylene (FEP), polypropylene, polyethylene, polyethylene terephthalate (PET). The transfer medium may be treated to improve release of the catalyst layer. Surface treatments may include, but not limited to; silicone, flame-treated silicone, fluorination, fluorosilicate. Since the transfer medium (decal) needs to release the coating layer, base materials or base materials and surface treatments are targeted to result in a adhesion of under 50 J/m2, and always less than the adhesion or peel force of the catalyst-electrode layer to the membrane.

Transfer of the catalyst layer from the transfer medium to the membrane may be completed by any suitable means, including batchwise and continuous means. An overlayer may be applied to the catalyst layer prior to transfer to improve the decal transfer. The overlayer may comprise of polymeric dispersion, water, nonaqueous solvent, or mixture of. Typically, the membrane is sandwiched between two catalyst coated transfer mediums, heat and pressure are then applied for a specified time. The applied temperature is typically from 60-180° C. and applied pressure of 1-10 tons over the membrane or an exposed area thereof (e.g., if mounted within a gasket), depending the specifics of fabrication. The transfer medium is then peeled away, resulting in catalyst adherence to the membrane.

The present invention improves membrane electrode assemblies via:
A) Providing a simplified procedure of obtaining MEAs from a decal process with acid doped polymer electrolyte membranes.
B) Catalyst coated membranes can be obtained by direct coating and decal transfer.
C) Complete transfer of catalyst layer to membrane.
D) Improved contact between catalyst layer and polymer electrolyte membrane.
E) Improved ohmic resistance compared to catalyst coated gas diffusion layers.
F) Decreasing catalyst loading in MEA

### EXAMPLE 1

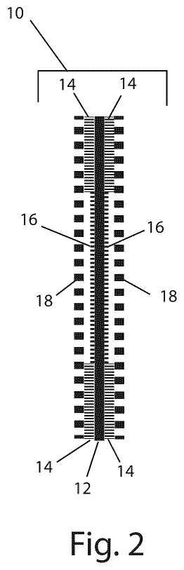

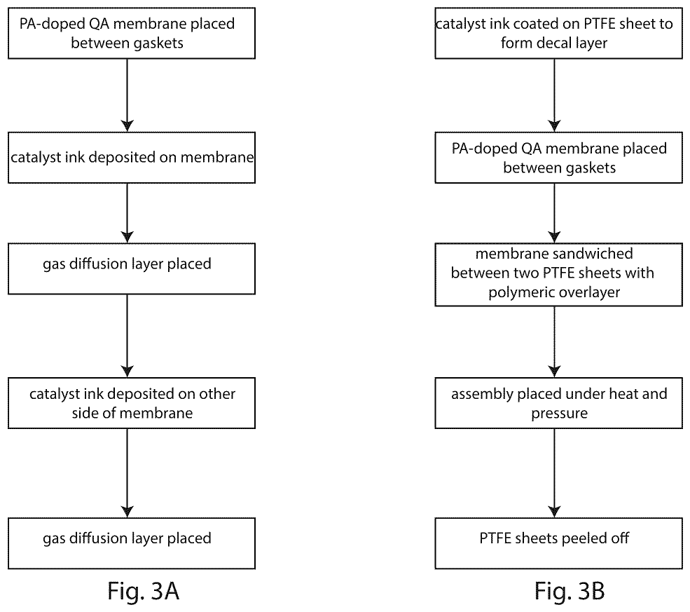

A membrane electrode assembly 10 of the type shown in FIG. 2 was formed as described below and illustrated in FIG. 3A.

A phosphoric acid doped quaternary ammonium membrane 12 from OrionPolymers was placed in between Kapton gaskets 14 with an exposed membrane area of 45 cm2. Catalyst ink composed of Pt/C, perfluorosulfonic acid and phosphonated polypentafluorostyrene was deposited onto the membrane and a doctor blade was used to obtain a uniform catalyst layer 16. Two coats were passed over to obtain the cathode electrode. A gas diffusion layer 18 was placed on the cathode layer. The coated membrane was flipped to expose the uncoated side of the membrane. Catalyst ink was deposited onto the membrane and a doctor blade was used to obtain a uniform layer in a single pass. A gas diffusion layer was placed onto the catalyst coated membrane.

### EXAMPLE 2

Catalyst inks composed of Pt/C, perfluorosulfonic acid and phosphonated polypentafluorostyrene were coated onto a polytetrafluoroethylene sheet to obtain a decal catalyst layer. A phosphoric acid doped PBI membrane was placed in between Kapton gaskets with an exposed membrane area of 5 cm2. The PBI assembly was sandwiched in between two catalyst coated PTFE sheets with a polymeric overlayer. The assembly was then placed in a hot press set to 120° C. The pressure was increased to 2 Tons and held for 30 minutes. The temperature was then increased to 160° C. and held at a pressure of 2 tons. The pressure was released after 30 minutes, and the PTFE sheets were peeled off. Majority of the catalyst was transferred to the membrane. However, a major decrease in membrane thickness was seen which is indicative of severe acid loss. In some embodiments, a membrane electrode assembly of the type shown in FIG. 2 was formed from the catalyst-covered membrane.

### EXAMPLE 3

Catalyst inks composed of Pt/C, perfluorosulfonic acid and phosphonated polypentafluorostyrene were coated onto a polytetrafluoroethylene sheet to obtain a decal catalyst layer. A phosphoric acid doped PBI membrane was placed in between Kapton gaskets with an exposed membrane area of 5 cm². The PBI assembly was sandwiched in between two catalyst coated PTFE sheets with a polymeric overlayer. The assembly was then placed in a hot press set to 120° C. The pressure was increased to 2.5 tons. The pressure was released after 5 minutes, and the PTFE sheets were peeled off. The catalyst loading on the PTFE sheets was unchanged and no transfer of catalyst to the PBI occurred.

### EXAMPLE 4

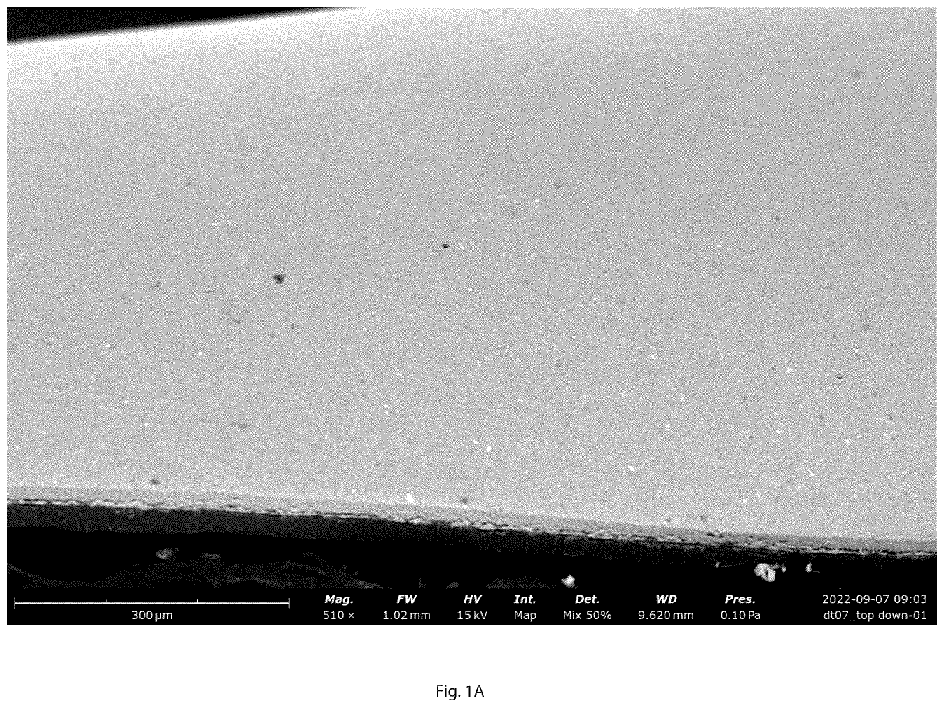

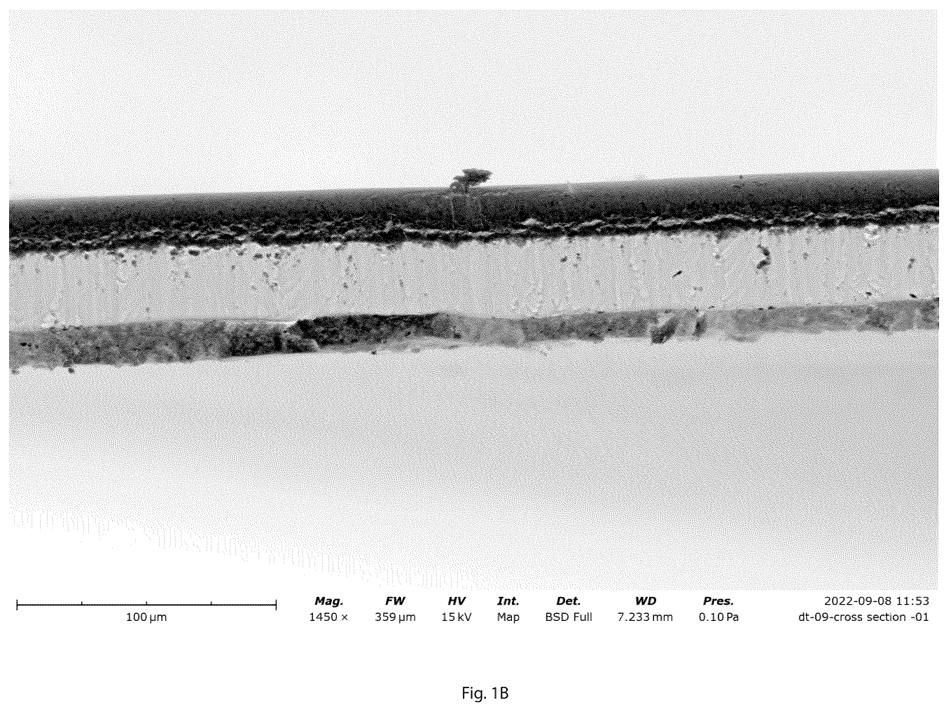

Referring to the process illustrated in FIG. 3B, catalyst inks composed of Pt/C, perfluorosulfonic acid and phosphonated polypentafluorostyrene were coated onto a polytetrafluoroethylene sheet to obtain a catalyst decal layer. A phosphoric acid doped quaternary ammonium membrane from OrionPolymers was placed in between Kapton gaskets with an exposed membrane area of 5 cm². The membrane assembly was sandwiched in between two catalyst coated PTFE sheets with a polymeric overlayer. The assembly was then placed in a hot press set to 120° C. The pressure was increased to 2.5 tons. The pressure was released after 5 minutes, and the PTFE sheets were peeled off. The PTFE sheet displayed no remnants of catalyst layer indicating complete transfer of catalyst layer to membrane. X-ray fluorescence was used to confirm the absence of catalyst on the PTFE sheet. The scanning electron micrographs of FIG. 1A and FIG. 1B confirm transfer and uniform coverage of the catalyst layer to the membrane. In some embodiments, a membrane electrode assembly of the type shown in FIG. 2 was formed from the catalyst-covered membrane.

The present disclosure is to be considered as an illustration of the invention in practice and not intended to limit the scope of the present invention to the particulars of the description, figures and examples provided.

In view of the foregoing, what we claim is:

1. A method of fabricating a catalyst coated membrane comprising:
A. providing a polymer electrolyte membrane comprising cationic-bisphosphate ion pair groups,
B. transferring a catalyst to the polymer electrolyte membrane by a direct transfer process.

2. The method of claim 1, wherein step B comprises
i. providing a catalyst ink,
ii. transferring the catalyst to the polymer electrolyte membrane by any
(a) directly coating or depositing the catalyst ink onto the polymer electrolyte membrane, and
(b) coating or depositing the catalyst ink on a release medium and transferring the catalyst from the release medium to the polymer electrolyte membrane.

3. The method of claim 2, comprising maintaining a content of phosphoric acid of the membrane in a range of about 0.5 mg/cm² during the transferring step.

4. The method of claim 2, wherein the catalyst ink has (i) a viscosity from 30-10,000 cP, (ii) a solid particle size from 0.01-5 μm, and (iii) a surface tension from 15-80 mN/m.

5. The method of claim 2, wherein a layer of the catalyst adheres to the polymer electrolyte membrane (i) with an energy density of at least about 100 J/m² to 1,000 J/m², and (ii) such that a force needed to peel a one-meter-wide strip of catalyst from adhesion to the polymer electrolyte membrane is of about 100 N/m up to 1,000 N/m.

6. The method of claim 2, wherein the catalyst ink comprises a dispersion of catalyst particles and a polymeric binder.

7. The method of claim 6, wherein the polymeric binder comprises functional groups that include any of a sulfonic acid, quaternary amine cation, and phosphonate.

8. The method of claim 6, wherein the catalyst ink comprises 5-15% solids, where solids are polymeric binder and catalyst particles.

9. The method of claim 6, wherein the catalyst particles are carbon supported particles that comprise about 40-90% carbon and 10-60% catalyst by weight.

10. The method of claim 9, wherein the catalyst comprises any of platinum and a platinum alloy of a transition metal or any mixture of two or more transition metals.

11. The method of claim 10, wherein the phosphoric acid-doped polymer electrolyte membrane has a loading of any of platinum and platinum alloy of about 0.01 mg/cm² to 5 mg/cm² after the transferring step.

12. A method of fabricating a catalyst coated membrane comprising:
A. providing a phosphoric acid doped quaternary ammonium membrane,
B. transferring a catalyst to the membrane by a direct transfer process.

13. The method of claim 12, wherein the polymer electrolyte membrane comprises quaternary ammonium-biphosphate ion pair groups.

14. The method of claim 12, wherein step B comprises
i. providing a catalyst ink,
ii. transferring the catalyst to the phosphoric acid doped quaternary ammonium membrane by any
(a) directly coating or depositing the catalyst ink onto the phosphoric acid doped quaternary ammonium membrane, and
(b) coating or depositing the catalyst ink on a release medium and transferring the catalyst from the release medium to the phosphoric acid doped quaternary ammonium membrane.

15. The method of claim 14, comprising maintaining a content of phosphoric acid of the phosphoric acid doped quaternary ammonium membrane in a range of about 0.5 mg/cm² during the transferring step.

16. The method of claim 14, wherein the catalyst ink has (i) a viscosity from 30-10,000 cP, (ii) a solid particle size from 0.01-5 μm, and (iii) a surface tension from 15-80 mN/m.

17. The method of claim 14, wherein a layer of the catalyst adheres to the phosphoric acid doped quaternary ammonium membrane (i) with an energy density of at least about 100 J/m² to 1,000 J/m², and (ii) such that a force needed to peel a one-meter-wide strip of catalyst from adhesion to the phosphoric acid doped quaternary ammonium membrane is of about 100 N/m up to 1,000 N/m.

18. A method of fabricating a catalyst coated membrane comprising:
A. providing a polymer electrolyte membrane comprising cationic-bisphosphate ion pair groups,
B. transferring a catalyst to the polymer electrolyte membrane by coating or depositing a catalyst ink on a release medium sheet and transferring the catalyst from the release medium to the polymer electrolyte membrane,
C. wherein the transferring step includes sandwiching the polymer electrolyte membrane between two release medium sheets on which the catalyst ink has been coated or deposited, applying heat and pressure thereto, and peeling away the release medium.

19. A membrane electrode assembly comprising
A. a catalyst coated membrane according to the method of any of claim 1, 12 or 18,
B. a gas diffusion layer disposed adjacent each of first and second sides of the catalyst coated membrane.
